(19) United States
(12) Patent Application Publication
(10) Pub. No.: US 2007/0035863 A1
(43) Pub. Date: Feb. 15, 2007

(54) Camouflaged hunting mirror

(76) Inventor: Angie E. Rogers, Brant, MI (US)

Correspondence Address: Galasso & Associates, LP, P.O. Box 26503, Austin, TX, 78755-0503, US

(21) Appl. No.: 11/200,769

(22) Filed: Aug. 10, 2005

(51) Int. Cl. G02B 5/08; G02B 7/182

(52) U.S. Cl. 359/850; 359/871

(57) ABSTRACT

A well camouflaged, highly adjustable and viewable mirror is provided for wider viewing and greater safety during hunting. The apparatus comprises a least one mirror and a plurality of mounting means. For camouflage, the mirror's reflective surface is tinted and concave, so that reflection from the mirror is reduced. Other parts of the mirror and mounting assembly are marked with a camouflaged pattern. The mirror can be adjusted through a ball and socket joint underneath the mirror and one or more telescoping shafts with tension collars. The mirror may be mounted on a pole, used with a step flange and spike or with a tripod. Alternately the mirror may be mounted in a tree or other support by a cable or Velcro mount or screws or bolts placed through holes in the mirror's base. Multiple mirrors may also be used to increase the hunter's ability to see in many different directions.

### FIELD OF THE DISCLOSURE

The present invention relates to mirrors and more particularly to a camouflaged mirror for use during hunting.

### BACKGROUND

Hunting is a favorite pastime for millions of enthusiasts each year. Hunters typically take up relatively stationary positions in hunting blinds or hidden areas to wait for game. When hunters are in position, it is important for them to be able to see the area around them clearly, including the area behind them, so that they can quickly and safely identify game as well as any other people or animals nearby. Hunting accidents sometimes occur when hunters mistake other people, including other hunters, for game.

The use of mirrors to enable hunters to see clearly behind them is known in the art. For example, U.S. Pat. No. 4,487,479 for Tolomelo provides a pocket-sized, three-part hunting mirror whose side parts can be swung open and which can be secured in position by adjustable strap that may be placed around a tree trunk, limb or pole. But a pocket-sized mirror is small, which may make it difficult to view clearly. It also may be difficult to adjust a three-part mirror into a position that provides adequate viewing. Moreover, a hunter may not always find it convenient to wrap a strap around a tree or pole to secure a mirror, for example when hunting in a treeless area or areas where there are no poles or when a hunting blind does not offer a support for the strap. In addition, a mirror may itself reflect light, from its reflecting surface, back, or other parts, so that game notices the reflection and avoids the hunter using the mirror.

Therefore, there is a need for a well camouflaged, highly adjustable hunting mirror that has multiple methods for mounting and can be larger than pocket sized.

### SUMMARY OF THE DISCLOSURE

The following explanation describes the present invention by way of example and not by way of limitation.

It is an aspect of the present invention to provide a well camouflaged, highly adjustable and viewable hunting mirror that comprises a least one mirror and multiple methods of mounting and that can be larger that pocket sized.

It is another aspect of the present invention to provide a hunting mirror that comprises a tinted, concave reflecting surface.

It is another aspect of the present invention to provide a hunting mirror that comprises exterior parts with a camouflaged pattern.

It is another aspect of the present invention to provide a hunting mirror that comprises multiple mirrors.

It is still another aspect of the present invention to provide a hunting mirror that is mountable by means of a step flange and a spike.

It is still another aspect of the present invention to provide a hunting mirror that is mountable by means of a tripod.

It is another aspect of the present invention to provide a hunting mirror that is adjustable by means of a ball and socket joint.

It is still another aspect of the present invention to provide a hunting mirror that is adjustable by means of at least one tension collar and at least one telescoping shaft.

It is still another aspect of the present invention to provide a hunting mirror that is mountable by means of a cable or Velcro mount.

It is still another aspect of the present invention to provide a hunting mirror that is mountable by means of holes in its base for screws or bolts.

These and other aspects of the present invention will become readily apparent upon further review of the following specification and associated drawings. In accordance with the present invention, a well camouflaged, highly adjustable and viewable mirror is provided for wider viewing and greater safety during hunting. The apparatus comprises a least one mirror and a plurality of mounting means. For camouflage, the mirror's reflective surface is tinted and concave, so that reflection from the mirror is reduced. Other parts of the mirror and mounting assembly are marked with a camouflaged pattern. The mirror can be adjusted through a ball and socket joint underneath the mirror and one or more telescoping shafts with tension collars. The mirror may be mounted on a pole, used with a step flange and spike or with a tripod. Alternately the mirror may be mounted in a tree or other support by a cable or Velcro mount or screws or bolts placed through holes in the mirror's base. Multiple mirrors may also be used to increase the hunter's ability to see in many different directions.

### BRIEF DESCRIPTION OF THE DRAWINGS

The following embodiments of the present invention are described by way of example only, with reference to the accompanying drawings, in which:

FIG. 1 is a block diagram that illustrates a camouflaged, highly adjustable and viewable hunting mirror;

FIG. 2 is a block diagram that illustrates a hunting mirror with multiple mirrors;

FIG. 3 is a block diagram that illustrates a tripod base for a hunting mirror; and

FIG. 4 is a block diagram that illustrates a hunting mirror that may be mounted by means of a cable mount or holes in the base for screws or bolts.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

The present invention comprises a well camouflaged, highly adjustable and viewable hunting mirror for wider viewing and greater safety during hunting. In an embodiment the camouflaged hunting mirror may be manufactured of a strong, durable, and lightweight material, for example a non-corrosive metal, such as aluminum, or a plastic.

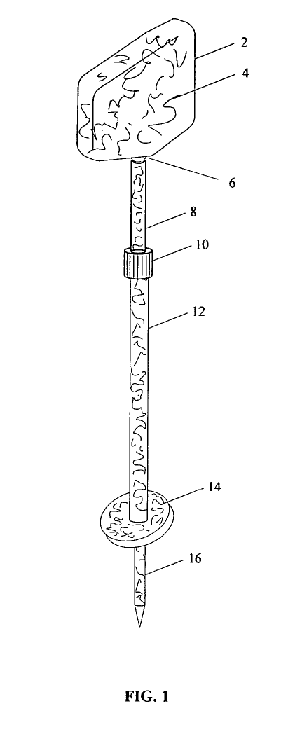

As shown in FIG. 1, the camouflaged hunting mirror comprises the following elements:
At least one tinted, concave mirror 2,
A camouflaged pattern 4 on exterior parts,
Means of mounting the mirror 2, and
Means of adjusting the mirror 2.

In an embodiment, the mirror 2 is six inches or larger in diameter. It should be made of durable material, such as metal or plastic, and may be round or rectangular in shape. The reflective surface of the mirror 2 is tinted to reduce reflections of light from the mirror that animals might see. The concave shape of the reflective surface of the mirror 2 also breaks up reflections of light from the mirror 2 for further camouflage.

In addition, the camouflaged pattern 4 on exterior parts of the mirror 2 and of other elements of the apparatus disguises the apparatus so that animals cannot see it, as is well known by those skilled in the art.

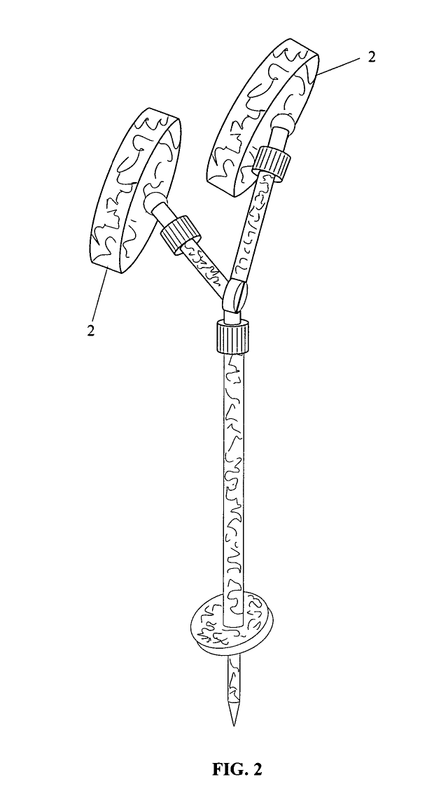

In another embodiment, the hunting mirror may comprise a plurality of mirrors 2, as shown in FIG. 2. Moreover, interchangeable mirrors 2 of different sizes may be provided, for example six inches in diameter and twelve inches in diameter, so that hunters can choose mirrors 2 of the best size for their circumstances. In still another embodiment, the arms supporting the mirrors 2 fold down for storage and convenience.

Returning to FIG. 1, in an embodiment the means of mounting comprises a pole 12, a step flange 14, and a spike 16. Hunters can press down on the step flange 14 with their feet to sink the spike 16 into the ground to set the hunting mirror in place.

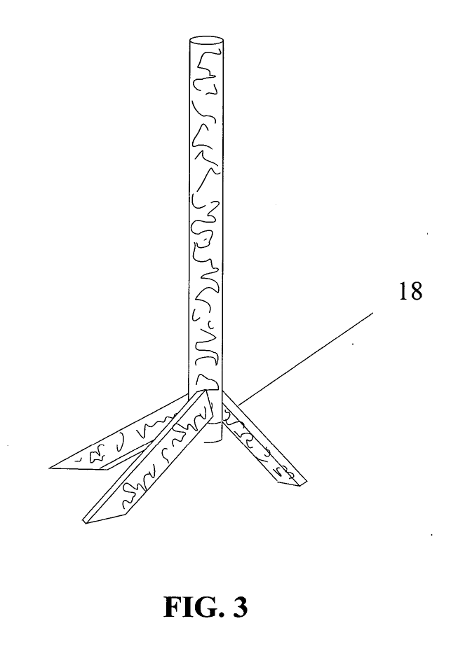

In other embodiments, other means of mounting may be used. For example, a tripod 18 may be used for mounting on the ground, as shown in FIG. 3. This may be especially useful for ground that is rocky, frozen, or in other ways too solid to be easily penetrated with a spike.

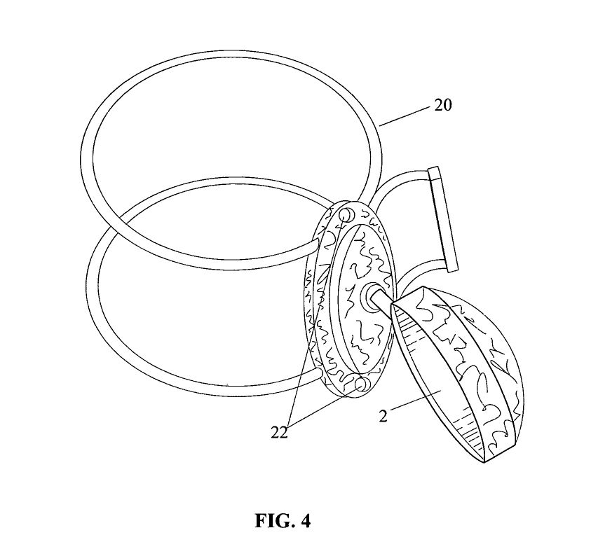

In still another embodiment shown in FIG. 4, a cable mount 20 may be used to mount the mirror 2 on a tree trunk, limb, or pole. Other techniques may also be used to mount the mirror on these or other surfaces. For example, holes 22 in the base of the mirror 2 may be provided so that the user can employ wood screws to attach the mirror 2 to a wooden hunting blind or any other wooden surface. Metal bolts may be placed through the holes 22 to attach the mirror 2 to a metal hunting blind or other metal surface. In addition, the cable mount 20 may be replaced by other materials, such as Velcro.

Several means of adjusting the mirror 2 may be employed. In an embodiment the mirror 2 comprises a ball and socket joint 6 underneath it, so that, however the mirror 2 is mounted, the mirror 2 can be moved into different positions to provide optimum viewing of the area which the hunter wishes to see.

In an embodiment, the hunting mirror may be further adjusted by means of at least one telescoping shaft 8 and at least one tension collar 10. The hunter can adjust a tension collar 10 to raise a telescoping shaft 8 from within a pole 12 or to lower the telescoping shaft 8 into the pole 12. In an embodiment, the telescoping shafts and poles may fold down for storage and convenience, or they may be replaced by segments that fold down.

The hunting mirror and its components may be carried in a carrying case with a zipper and folding strap and manufactured of a durable, lightweight material which may be a non-friction or waterproof material.

Use

Hunters would typically purchase the style of hunting mirror they are likely to need and place it in front of them when they are hunting. For example, hunters might buy hunting mirrors with step flanges 14, shown in FIG. 1, and spikes 16 for use in easily penetrable soil, in a pine forest for example. They might buy hunting mirrors with tripods 18, shown in FIG. 3, for use in rock or frozen soil, for example on an Alaskan mountain. Or they might buy hunting mirrors with cable mounts 20, shown in FIG. 4 for use with trees, limbs, poles or other supports, or with holes 22 for screws and bolts for attaching the hunting mirror to a hunting blind or to other surfaces. In an embodiment, hunters would purchase a kit with multiple mounting means to which one or more mirrors 2 can be attached interchangeably as needed. Kits with multiple mirrors 2, shown in FIG. 2, may also be used for expanded viewing capabilities.

After mounting the mirror 2, hunters would adjust its position for best viewing by means of the mirror's ball and socket joint 6, shown in FIG. 1, and, if available, by means of one or more tension collars and telescoping shafts.

After adjusting the hunting mirror, hunters can remain hidden in their blinds or other positions and can use the mirror to see behind them. Addition views are possible through hunting mirrors with multiple mirrors. This increased capability for viewing enables hunters to identify game or other people and animals more quickly and safely. If hunters see another hunter in the mirror, they may also call out to alert the other hunter, so that they themselves are not mistaken for game.

The best dimensional relationships for the parts of the invention described above, including variations in form and use, will be readily apparent to those skilled in the art, and are intended to be encompassed by the present invention.

What is claimed is:

1. A camouflaged hunting mirror comprising
at least one mirror with a concave, tinted reflective surface,
a camouflaged pattern on exterior elements,
means of mounting the camouflaged mirror; and
means of adjusting the mirror.

2. The means of mounting the mirror of claim 1, wherein the means of mounting the mirror comprises
a pole,
a step flange, and
a spike.

3. The means of mounting the mirror of claim 1, wherein the means of mounting the mirror comprises
a pole, and
a tripod.

4. The means of mounting the mirror of claim 1, wherein the means of mounting the mirror comprises
a mounting device, such that the mounting device can go around a support, and holes in the base of the mirror, such that screws or bolts may be placed through the holes.

5. The mounting device of claim 4, wherein the mounting device comprises a cable mount.

6. The mounting device of claim 4, wherein the mounting device comprises a Velcro mount.

7. The means of adjusting the mirror of claim 1, wherein the means of adjusting the mirror comprises at least one ball and socket joint underneath the mirror.

8. The means of adjusting the mirror of claim 1, wherein the means of adjusting the mirror comprises
at least one telescoping shaft, and
at least one tension collar.

9. The means of adjusting the mirror of claim 1, wherein the means of adjusting the mirror comprises at least one folding segment.

10. A camouflaged hunting mirror comprising
at least one mirror with a concave, tinted reflective surface,
a camouflaged pattern on exterior elements,
a pole, such that the pole supports the mirror,
means of mounting the camouflaged hunting mirror on the ground, and
means of adjusting the mirror.

11. The means of mounting the camouflaged hunting mirror on the ground of claim 10, wherein the means of mounting the camouflaged hunting mirror on the ground comprises
a step flange, and
a spike.

12. The means of mounting the camouflaged hunting mirror on the ground of claim 10, wherein the means of mounting the camouflaged hunting mirror on the ground comprises
a tripod.

13. The means of adjusting the mirror of claim 10, wherein the means of adjusting the mirror comprises
at least one ball and socket joint underneath the mirror.

14. The means of adjusting the mirror of claim 10, wherein the means of adjusting the mirror comprises
at least one telescoping shaft, and
at least one tension collar.

15. The means of adjusting the mirror of claim 10, wherein the means of adjusting the mirror comprises at least one folding segment.

16. A camouflaged hunting mirror comprising
at least one mirror with a concave, tinted reflective surface;
a camouflaged pattern on exterior elements;
a mounting device, such that
the mounting device can go around a support, and
holes in the base of the mirror, such that screws or bolts may be placed through the holes, and
means of adjusting the mirror.

17. The mounting device of claim 16, wherein the mounting device comprises a cable mount.

18. The mounting device of claim 16, wherein the mounting device comprises a Velcro mount.

19. The means of adjusting the mirror of claim 16, wherein the means of adjusting the mirror comprises at least one ball and socket joint underneath the mirror.
